(19) United States
(12) Patent Application Publication
(10) Pub. No.: US 2008/0094348 A1
(43) Pub. Date: Apr. 24, 2008

(54) Liquid crystal display device with light sensor on light guide plate thereof

(75) Inventors: Fei Yin, Shenzhen (CN); Guo-Hua Yu, Shenzhen (CN); Yu-Hsun Jen, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 11/906,466

(22) Filed: Oct. 1, 2007

(30) Foreign Application Priority Data
Sep. 29, 2006 (TW) 95136318

(51) Int. Cl. G02F 1/13357; G09G 3/22

(52) U.S. Cl. 345/102; 349/65

(57) ABSTRACT

An exemplary liquid crystal display device (200) includes a liquid crystal panel (220), a light guide plate (210) opposite to the liquid crystal panel, a light source configured for supplying light beams to the light guide plate, a driving chip (230) provided at the light guide plate and configured for driving the liquid crystal panel, and a light sensor (240) disposed on the light guide plate. The light sensor senses a brightness of the external environment, and transmits a signal indicating the brightness to the driving chip. The driving chip receives and processes the signal, and adjusts a brightness of the light source such that an image displayed by the liquid crystal panel is adjusted according to the brightness of the external environment.

### FIELD OF THE INVENTION

The present invention relates to a liquid crystal display (LCD) device having a light sensor disposed on a light guide plate (LGP) of the LCD device, whereby a brightness of the LCD device can be adjusted automatically.

### BACKGROUND

A typical LCD device has the advantages of portability, low power consumption, and low radiation, and has been widely used in various portable information products such as notebooks, personal digital assistants (PDAs), video cameras, and the like.

Referring to FIG. 5, a conventional LCD device 100 includes an LGP 110, a light source assembly 120, a plurality of optical films 150, a liquid crystal panel 160, and a frame 170. The LGP 110, the optical films 150, and the liquid crystal panel 160 are accommodated in the frame 170, in that order from bottom to top.

The LGP 110 includes a light emitting surface 111, and a light incident surface 112 adjoining the light emitting surface 111. The light source assembly 120 includes a flexible printed circuit board (FPCB) 121, and four light emitting units 122 disposed on the FPCB 121. The light source assembly 120 is disposed adjacent to the light incident surface 112 of the LGP 110.

The liquid crystal panel 160 includes a color filter substrate (not labeled), a thin film transistor (TFT) substrate (not labeled), a liquid crystal layer (not visible) between the color filter substrate and the TFT substrate, and two polarizers 161, 163. The two polarizers 161, 163 have mutually perpendicular polarizing axes, and are attached on outer surfaces of the two substrates respectively. The TFT substrate includes a plurality of gate lines and data lines 165, a driving chip 166, and a plurality of conducting lines 167. The driving chip 166 is connected to the gate lines and data lines 165, and is electrically connected to an external circuit (not shown) via the conducting lines 167.

The LCD device 100 further includes a light sensor (not shown) disposed on the liquid crystal panel 160. The light sensor is electrically connected to a brightness control circuit (not shown) via a plurality of lines (not shown) arranged on the TFT substrate. The light sensor senses variations in the brightness of the external environment, and transmits signals corresponding to such variations to the brightness control circuit. Then the brightness control circuit adjusts a brightness of light generated by the light source assembly 120 according to the signals transmitted from the light sensor. A brightness of images display by the liquid crystal panel 160 is adjusted accordingly. Thus the LCD device 100 can automatically adjust its display brightness according to variations in the brightness of the external environment, and thereby provide optimal image display quality to users of the LCD device 100.

However, the gate lines and data lines 165 and the conducting lines 167 all arranged on the TFT substrate are numerous. This makes the layout of the TFT substrate complicated. In addition, the high density of lines 165, 167 is liable to produce electromagnetic interference (EMI) therebetween.

What is needed, therefore, is an LCD device that can overcome the above-described deficiencies.

### SUMMARY

An aspect of the invention relates to a liquid crystal display device. The liquid crystal display device includes a liquid crystal panel, a light guide plate opposite to the liquid crystal panel, a light source configured for supplying light beams to the light guide plate, a driving chip provided at the light guide plate and configured for driving the liquid crystal panel, and a light sensor disposed on the light guide plate. The light sensor senses a brightness of the external environment, and transmits a signal indicating the brightness to the driving chip. The driving chip receives and processes the signal, and adjusts a brightness of the light source such that an image displayed by the liquid crystal panel is adjusted according to the brightness of the external environment.

Another aspect of the invention relates to a liquid crystal display device, wherein the liquid crystal display device includes a liquid crystal panel, a light guide plate opposite to the liquid crystal panel, a light source configured for supplying light beams to the light guide plate, a driving chip provided at the light guide plate and configured for driving the liquid crystal panel, and a light sensor configured for measuring a brightness of the external environment. The light sensor is disposed on the light guide plate, the driving chip receives and processes signals received from the light sensor indicating the brightness of the external environment, and adjusts a luminance of the light source accordingly.

Other novel features and advantages will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of at least one embodiment of the present invention. In the drawings, like reference numerals designate corresponding parts throughout various views, and all the views are schematic.

FIG. 1 is a side view of an LCD device according to a preferred embodiment of the present invention, the LCD device including an LGP.

FIG. 2 is an enlarged, cross-sectional view of part of the LCD device of FIG. 1, taken along line II-II thereof.

FIG. 3 is an exploded, isometric, abbreviated view of the LCD device of FIG. 1.

FIG. 4 is an isometric view of an LGP of an LCD device according to an alternative embodiment of the present invention.

FIG. 5 is an exploded, isometric view of a conventional LCD device.

### DETAILED DESCRIPTION OF PREFERRED EMBODIMENTS

Reference will now be made to the drawings to describe preferred and exemplary embodiments of the present invention in detail.

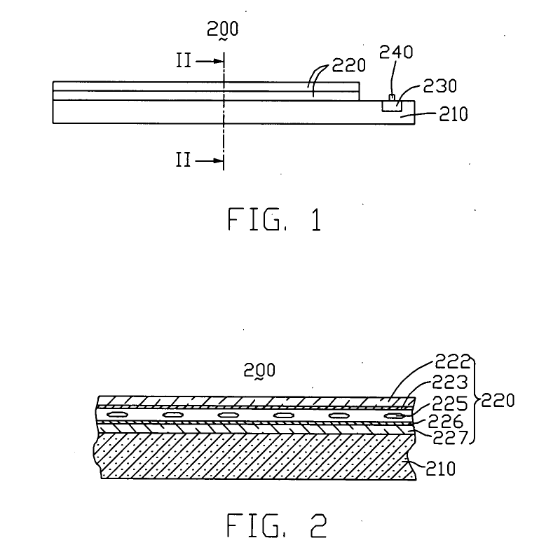

Referring to FIG. 1, an LCD device according to a preferred embodiment of the present invention is shown. The LCD device 200 includes an LGP 210, a liquid crystal panel 220, a driving chip 230, and a light sensor 240. The liquid crystal panel 220 and the LGP 210 are opposite to each other. The driving chip 230 and the light sensor 240 are disposed on the LGP 210. In the illustrated embodiment, the driving chip 230 is at least partially embedded in the LGP 210. In an alternative embodiment, the driving chip 230 can be mounted on the LGP 210 via an anisotropic conductive film.

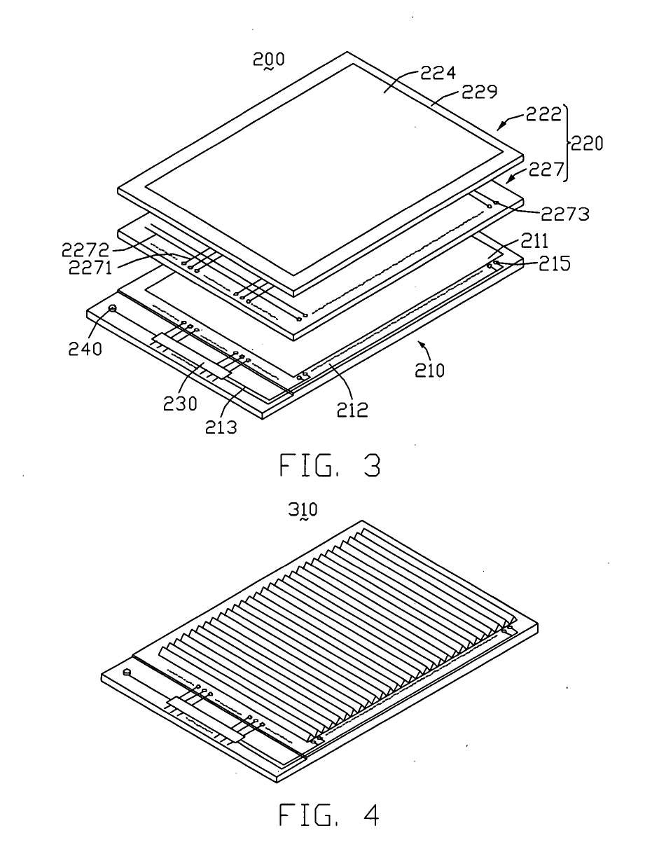

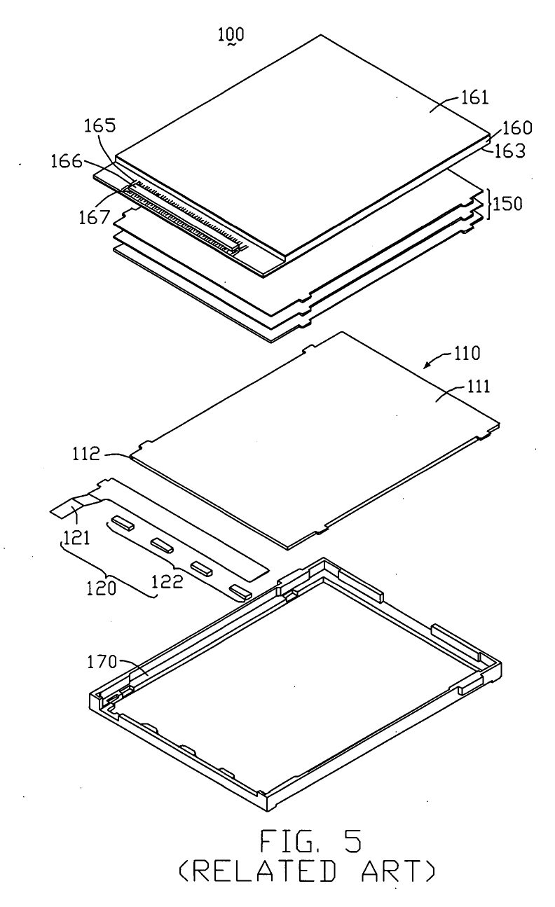

Referring also to FIG. 2, the liquid crystal panel 220 includes a color filter substrate 222, a TFT substrate 227, and a liquid crystal layer 225 between the color filter substrate 222 and the TFT substrate 227. Two polarizers 223, 226 are respectively disposed on inner surfaces of the color filter substrate 222 and the TFT substrate 227, with the polarizers 223, 226 being adjacent to the liquid crystal layer 225. The polarizers 223, 226 may be made of polyvinyl alcohol (PVA). Because the polarizers 223, 226 are disposed on the inner surfaces of the color filter substrate 222 and the TFT substrate 227, the polarizers 223, 226 cannot be scratched easily. Thus, protective layers of the polarizers 223, 226 can be omitted from the LCD device 200.

Referring also to FIG. 3, the liquid crystal panel 220 includes a central display area 224, and a non-display area 229 surrounding the display area 224. The TFT substrate 227 includes a plurality of gate lines 2271 that are parallel to each other, a plurality of data lines 2272 that are parallel to each other, and a plurality of connecting ports 2273. The gate lines 2271 and the data lines 2272 intersect each other, and are disposed corresponding to the display area 224. The connecting ports 2273 are arranged corresponding to the non-display area 229, and are connected to endings at one side of the gate lines 2271 and endings at one side of the data lines 2272, respectively. The connecting ports 228 are so-called conducting holes. Walls bounding the conducting holes can be coated with electrically conductive material via a welding process, so that the conducting holes can conduct electricity. Alternatively, the connecting ports 228 can be vias.

The LGP 210 may be made of glass, and includes a central light-guiding area 211, and a wiring area 212 surrounding the light-guiding area 211. The light-guiding area 211 corresponds to the display area 224 of the liquid crystal panel 220. The wiring area 212 includes a plurality of conducting lines 213 and a plurality of connecting terminals 215. The connecting terminals 215 are conducting holes defined in the LGP 210. Walls bounding the conducting holes can be coated with electrically conductive material via a welding process, so that the conducting holes can conduct electricity. Alternatively, the connecting terminals 215 can be vias. The connecting terminals 215 correspond to the connecting ports 2273 of the TFT substrate 227. The driving chip 230 can be disposed on the wiring area 212 of the LGP 210, and the light sensor 240 can be attached on or integrated with the wiring area 212. The driving chip 230 is connected to the light sensor 240, the connecting terminals 215, and an external circuit (not shown) via corresponding conducting lines 213.

The driving chip 230 has one or more side surfaces (not shown). A light source (not shown) supplying light beams to the LGP 210 may be one or more light emitting diodes (LEDs), which can be formed by depositing suitable semiconductor material on the side surfaces of the driving chip 230. A driving circuit (not shown) for the light source can be integrated into the driving chip 230. The driving chip 230 further includes a gate driving circuit (not shown), a data driving circuit (not shown), and a brightness control circuit (not shown). The driving chip 230 is electrically connected to the connecting terminals 215 of the LGP 210, and is thereby connected to the connecting ports 2273 of the TFT substrate 227. Thus, the driving chip 230 can drive the liquid crystal panel 220 to display images.

The light sensor 240 senses a brightness of the external environment, transforms received light signals to electrical signals, and transmits the electrical signals to the brightness control circuit of the driving chip 230. Then the brightness control circuit of the driving chip 230 controls the driving circuit to change a luminance of the light source according to the electrical signals received. A brightness of images display by the liquid crystal panel 220 is adjusted accordingly. Thus the LCD device 200 can automatically adjust its brightness according to variations in the brightness of the external environment, and thereby provide optimal image display quality to users of the LCD device 200.

Due to the wiring area 212 provided on the LGP 210, the driving chip 230 and the light sensor 240 can be disposed on the LGP 210. In the illustrated embodiment, the driving chip 230 is at least partially embedded in the LGP 210. This arrangement saves on the amount of layout space required of the TFT substrate 227. In addition, compared to a conventional LCD device, the layout of conducting gate lines 2271, conducting data lines 2272, and conducting lines 213 is less dense. This helps prevent the LCD device 200 from producing EMI.

Referring to FIG. 4, an LGP 310 of an LCD device according to an alternative embodiment of the present invention is shown. The LGP 310 is similar to the LGP 210. However, the LGP 310 includes a plurality of microstructures (not labeled) provided at a surface thereof adjacent to the liquid crystal panel (not shown). The microstructures have light diffusing capability, so that light beams emitting from the LGP 310 are more uniform. In the illustrated embodiment, the microstructures are a plurality of parallel prisms.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A liquid crystal display device, comprising:
a liquid crystal panel;
a light guide plate opposite to the liquid crystal panel;
a light source configured for supplying light beams to the light guide plate;
a driving chip provided at the light guide plate, the driving chip configured for driving the liquid crystal panel; and
a light sensor disposed on the light guide plate;
wherein the light sensor senses a brightness of the external environment, and transmits a signal indicating the brightness to the driving chip, the driving chip receives and processes the signal, and adjusts a brightness of the light source such that an image displayed by the liquid crystal panel is adjusted according to the brightness of the external environment.

2. The liquid crystal display device as claimed in claim 1, wherein the liquid crystal panel comprises a display area and a non-display area surrounding the display area.

3. The liquid crystal display device as claimed in claim 2, wherein the liquid crystal panel further comprises a thin film transistor substrate, the thin film transistor substrate comprises a plurality of gate lines, a plurality of data lines, and a plurality of connecting ports, the connecting ports are disposed on the thin film transistor substrate at the non-display area, and the connecting ports are connected to the gate lines and the data lines.

4. The liquid crystal display device as claimed in claim 3, wherein the light guide plate comprises a light-guiding area and a wiring area surrounding the light-guiding area, and the light-guiding area corresponds to the display area of the liquid crystal panel.

5. The liquid crystal display device as claimed in claim 4, wherein the light sensor is disposed on the wiring area of the light guide plate.

6. The liquid crystal display device as claimed in claim 5, wherein the wiring area comprises a plurality of conducting lines and a plurality of connecting terminals, the connecting terminals correspond to the connecting ports of the thin film transistor substrate, and the light sensor is coupled to the connecting terminals via the conducting lines.

7. The liquid crystal display device as claimed in claim 6, wherein the driving chip is disposed at the wiring area, the driving chip is coupled to the light sensor and the connecting terminals via the conducting lines, and the driving chip drives the liquid crystal panel via electrical connection with the connecting terminals of the light guide plate and the connecting ports of the thin film transistor substrate.

8. The liquid crystal display device as claimed in claim 1, wherein the driving chip comprises a gate driving circuit, a data driving circuit, and a brightness control circuit.

9. The liquid crystal display device as claimed in claim 1, wherein the driving chip is at least partially embedded in the light guide plate.

10. The liquid crystal display device as claimed in claim 9, wherein the light source comprises semiconductor material deposited at one or more side surfaces of the driving chip.

11. The liquid crystal display device as claimed in claim 10, further comprising a driving circuit for driving the light source, wherein the driving circuit is integrated in the driving chip.

12. The liquid crystal display device as claimed in claim 1, wherein the light guide plate is made of glass, and the driving chip is mounted on the light guide plate via an anisotropic conductive film.

13. The liquid crystal display device as claimed in claim 1, wherein the light guide plate comprises a plurality of microstructures provided at a surface thereof adjacent to the liquid crystal panel.

14. The liquid crystal display device as claimed in claim 3, wherein the liquid crystal panel further comprises a color filter substrate, and a liquid crystal layer between the color filter substrate and the thin film transistor substrate.

15. The liquid crystal display device as claimed in claim 14, wherein the liquid crystal panel further comprises a polarizer disposed on an inner surface of the color filter substrate generally adjacent to the liquid crystal layer.

16. The liquid crystal display device as claimed in claim 15, wherein the liquid crystal panel further comprises another polarizer disposed on an inner surface of the thin film transistor substrate generally adjacent to the liquid crystal layer.

17. A liquid crystal display device, comprising:
a liquid crystal panel;
a light guide plate opposite to the liquid crystal panel;
a light source configured for supplying light beams to the light guide plate;
a driving chip provided at the light guide plate, the driving chip configured for driving the liquid crystal panel; and
a light sensor configured for measuring a brightness of the external environment;
wherein the light sensor is disposed on the light guide plate, the driving chip receives and processes signals received from the light sensor indicating the brightness of the external environment, and adjusts a luminance of the light source accordingly.

18. The liquid crystal display device as claimed in claim 17, wherein the driving chip is at least partially embedded in the light guide plate.

19. The liquid crystal display device as claimed in claim 18, wherein the light source comprises semiconductor material deposited on one or more side surfaces of the driving chip.

20. A method of adjusting illumination of a liquid crystal display device, comprising:
providing a liquid crystal panel;
providing a light guide plate opposite to the liquid crystal panel;
providing a light source configured for supplying light beams to the light guide plate;
providing a driving chip on the light guide plate, the driving chip configured for driving the liquid crystal panel; and
disposing a light sensor on the light guide plate and directly intimately contacting the driving chip;
wherein the light sensor senses a brightness of the external environment, and transmits a signal indicating the brightness to the driving chip, the driving chip receives and processes the signal, and adjusts a brightness of the light source such that an image displayed by the liquid crystal panel is adjusted according to the brightness of the external environment.
